(19) United States
(12) Patent Application Publication
(10) Pub. No.: US 2007/0028165 A1
(43) Pub. Date: Feb. 1, 2007

(54) Dynamic layout system and processes

(76) Inventor: Lee Cole, Denver, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 10/063,319

(22) Filed: Apr. 10, 2002

Related U.S. Application Data
(60) Provisional application No. 60/283,012, filed on Apr. 10, 2001.

(51) Int. Cl. G06F 17/00

(52) U.S. Cl. 715/517

(57) ABSTRACT

A completely free form layout of the physical content of a publication. The publication is represented as an unstructured set of content objects whose design relationships are specified as separate relationship objects, all of which interact with objects representing the properties of the display media. Through this representation, the present invention is better able to capture, represent and display the design intent of a designer throughout the entire design process.

This application claims benefit of priority of provisional application 60/283,012, filed on Apr. 10, 2001.

### BACKGROUND OF INVENTION

The publication of information has constantly evolved over time. Traditional publication of content has required a designer to physically layout the content in structural relationship on a document. Advances in technology have provided numerous aids for enabling users not only to more easily publish content but to do so in more creative forms. Desktop publishing has become increasingly more prevalent as tools become available. For example, a designer is able to use a layout tool such as QuarkXPress® by Quark, Inc. to associate text and graphics in a geometrical structural relationship relative to the page of the document to be published.

The advent of Internet and other network applications have allowed a myriad of different forms of content to be published. Content can be published not only as text and graphics but also as video, animation, audio, and other formats as well. Thus, new forms of layout tools are becoming necessary to enable the publication of content in these forms.

Another critical problem is the multiplicity of output media devices. Previously, a designer would create a document for content for a specific output, such as a newspaper, magazine page, etc. Presently, the designer may need to publish content for a plurality of output forms, not only for a specific print format, but for a computer monitor, a handheld personal digital assistant, multiple print formats, and other devices as well. The designer, with existing tools, must create specific documents for each specific output media even if the content is the same.

Designers are often confronted with the need to repurpose content between documents. Presently, this requires a new document to be specifically created to display the content in a new form. A designer creating new documents in this fashion is limited to creating documents for those devices known (to the designer) today. Devices entering the market tomorrow can not be accommodated without additional effort. Obviously, there is a point at which the (constant) effort needed to layout content for an additional device exceeds the benefit.

Another problem with current layout tools is the difficulty to separate design intent, that is the creative input of the designer, from the content and the output media. Typically, the output media and the content dictates the design of the document. This is frustrating for the designer as well limiting the ability to display content in creative forms. Also, existing tools tend to force structural limitations on the designer during the design process. Even the tools that do allow the designer to utilize their creative intent do not allow design intent to be separated from the final document. The design intent is merged into the final document and cannot be utilized.

Finally, the Internet has accelerated the rise of “pull” communications, where a consumer, for example, requests the latest information on a given topic based on their then-current interests for example the latest mortgage loan rates or up to the moment news and stock prices. These communications must be generated dynamically, without the design knowledge of the layout artist, and as such have the results have a very restricted level of artistic design.

There have been a number of attempts to solve these problems. For instance, applications have been developed that utilize templates to enable publication on a number of output devices. However these templates don”t adapt to differing circumstances, and do not allow design intent to be appropriately utilized. This is also true of applications that use parent-child or tree relationships between the content objects. Other applications use menu-driven or static layout changes between documents, such as in eXtensible Markup Language (XML) applications. These applications also limit the ability of designers to utilize their creative talents and are limited in use with differing output media displays.

Other attempts to solve these problems are disclosed in U.S. Pat. Nos. 5,903,902; 5,895,476; and 5,956,737; all assigned to Design Intelligence. These patents disclose using parent-tree structural relationships to separate design and content. However, this rigid structural approach limits the ability of designers to use their creative talents.

There presently exists a need for open design tools that enable designers to separate design intent from content, and to capture, represent and display the design intent through the design process; that allow content to be easily repurposed; and to allow the design intent and content to be published over any number of different output media devices.

### SUMMARY OF INVENTION

The present invention solves these and other problems. An embodiment of the present invention provides for the completely free form layout of the physical content of a publication. The publication is represented as an unstructured set of content objects whose design relationships are specified as separate relationship objects. These relationship objects may hold a purely physical relationship, such as two boxes that are aligned along their top edge. They may hold a purely logical relationship. An example of a purely logical relationship may be the need to emphasize or deemphasize a piece of content based on purely non-physical concerns; i.e. raising housing stories to prominence based on current mortgage interest rates, or deemphasizing war reporting for personalized flyers when the recipient is a member of a pacifist group. These logical relationship objects may reference external information, such as stock quotes or particular journalistic reporting.

Finally all of these objects interact with objects representing the properties of the display media. These display objects may consist of previously known and stored data, or they may be generated dynamically be querying the display device. Through this representation, the present invention is better able to capture, represent and display the design intent of a designer throughout the entire design process.

In one particular embodiment, the publication is arranged as an unstructured data collection representing content objects, a second unstructured data collection representing both logical and physical relationship objects, a third unstructured data collection representing the properties of one or more display devices, and a set of external logical relationships. Where the number of variables in the content object relationships, the logical relationships, and output media relationships equal the number of variable values, and represent exact equalities, the relationships can be translated into a set of linear equations that can be solved simultaneously. This solution specifies the values for all variables and determines the final layout of the publication.

In another embodiment, the number of relationships is too few to completely specify the variable values. In this application, an additional set of relationships is added to select an aesthetically pleasing solution. For example, an additional relationship may require that the aspect ration of an image be constrained to the “golden ratio”. In another embodiment of the present invention, the designer's final placement of content on one fixed output media device, is used to define a number of “preferred sizes” and relative position relationships for the physical layout of specific content. These relationships can them be applied to other physical output devices without the need to structure either the design or the content. Where the new output media parameters are significantly different, the layout can be chosen by minimizing the differences between the physical layout sizes and the “preferred sizes” of the content objects in the old output medium. Note that each content object may have multiple “preferred sizes” or any other property values. These multiple values may be selected based on other properties such as the color space used or specific output media.

In another preferred embodiment of the present invention, the relationships of all content areas are treated as a whole. In this embodiment, the placement of content areas is treated as input into a quality metric or measure. This measure can be very general. It may include such attributes as the amount and distribution of white space over the publication, or it may strive to maintain color balance over the face of a page. In this preferred embodiment, the solution is chosen by minimizing or maximizing the value of this measure using standard engineering techniques

### BRIEF DESCRIPTION OF DRAWINGS

FIG. 1 is a flow chart of the operation of a preferred embodiment of the system and processes of the present invention.

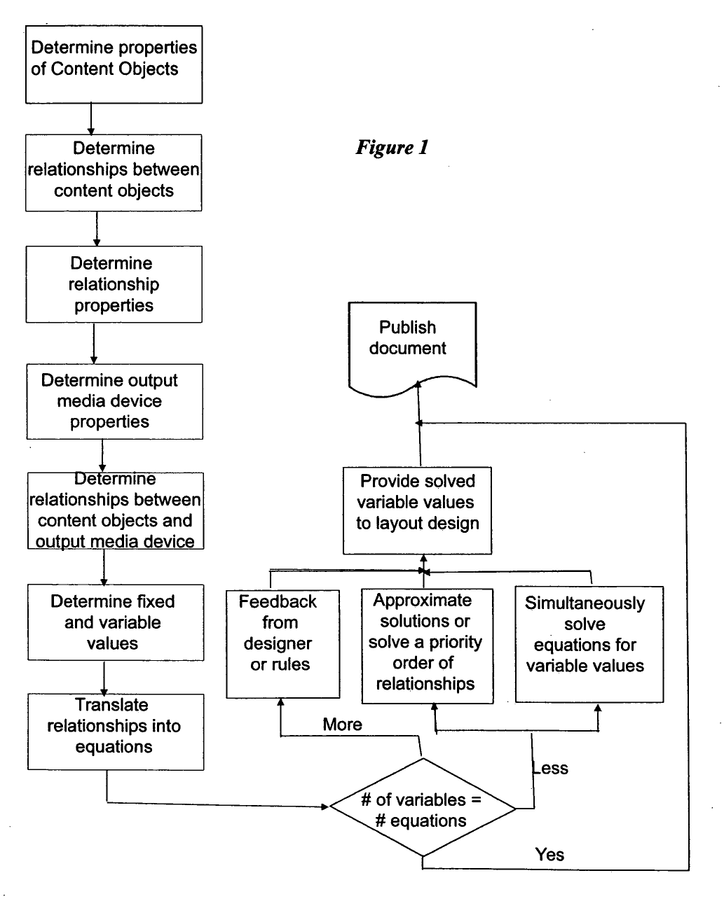

FIG. 2 is an illustration of an implementation of the embodiment of FIG. 1.

### DETAILED DESCRIPTION

The present invention provides systems and processes for dynamically arranging content for publication. The present invention, in a preferred embodiment, facilitates the capture, representation and utilization of publication design intent, content re-purposing and dynamic layout for differing output media devices, differing recipients, and at differing times. It is to be expressly understood that the exemplary preferred embodiments disclosed are for descriptive purposes and are not intended to limit the scope of the present invention. Other embodiments are within the scope of the claimed inventions.

The preferred embodiment of the present invention is intended for use in, but not limited to, a network environment including but not limited to Internet applications, intranet applications, wireless applications, other network applications, standalone computer applications and many other types of applications.

In a preferred embodiment of the present invention, the system and process provides a free form relationship (non-structural) with the information content to be published. The structural relationship is not necessary between the content but the logical relationship is maintained. For purposes of describing the present invention, information content is considered to be collected in “content objects”. The information content may be text, graphics, audio, video, animation, programming objects and any other type or format of information. Also, the document (collection of content objects) is itself a content object. These content objects can be of any shape and size as set forth by the designer. The content objects can also be allowed to overlap and also placed in “layers”, that is “overlaid” onto existing content objects.

The preferred embodiment of the present invention provides a system and processes for the completely free form layout of the physical content of a publication. The publication is represented as an unstructured set of content objects whose design relationships are specified as separate relationship objects, all of which interact with objects representing the properties of the display media, and which may further interact with objects representing external information (stock prices, customer histories, etc.) Through this representation, the present invention is better able to capture, represent and display the design intent of a designer throughout the entire design process.

Additional information is available about each of these content objects, generally about the type or class of content object and specifically about the specific content object. This information, generally referred to as the properties of the content object, includes such information as the type of content object (text, graphic, audio, video, etc.), the data file, box height and width of the content object, the size of the data file, and other useful information. Also, the styling properties of the information in the content objects are also properties of the content object. In the preferred embodiment of the present invention, these properties are classified as either “fixed” or “variable”. Examples of fixed properties include the type of object, aspect ratios, etc. Examples of variable properties include the relationship between the content objects, the stylistic characteristics of the content objects, etc.

Properties exist for output media devices. Output media is displayed in forms and devices including but are not limited to differing types of print publications (newspapers, magazines, brochures, newsletters, books, etc.), computer monitors, wireless applications, pagers, and other existing devices as well as devices being developed. The properties include such information as the viewer available for the different types of content object, whether such content objects are publishable on the particular media device, size of the viewer, etc.

Properties also exist for logical state or data references, such as the buying preferences of the intended recipient, the state of a current purchase transaction, or the price of a stock.

The preferred embodiment of the present invention collects the properties of the content objects. The system is able to “query” the content objects and the output media devices as to their properties. The system then attempts to assign optimum values to the variable properties.

The system is then able to collect, specify and/or define relationships between the content objects. These relationships may include physical or structural relationships between the content objects (images located relative to text), logical relationships (text and associated images, video, audio) and any other relevant relationships. These relationships themselves may have additional properties that may be fixed or variable. These relationships may also contain procedural descriptions, i.e., computer programming languages that can adapt the design in an dynamic fashion.

Similarly, the system collects, specifies and/or defines relationships between the output media devices and the content objects. These relationships include associated viewers for audio, video, graphic, text content objects, and other relevant relationships. These relationships may have properties as well, fixed and variable.

The system and processes of the preferred embodiment specify the content objects, the output device objects and relationships in a common language, preferably human readable. One implementation of this preferred embodiment uses an XML-based grammar for ease of use. In another preferred embodiment of the present invention, the system utilizes a proprietary Design Intent Meta Language or a Graphic Mark-Up Language.

Simultaneous Equation In the preferred embodiment, the system and processes of the present invention treat the variable properties as variables in one or more equations. The system, in a preferred embodiment, then solves these equations simultaneously without placing a prior order on the relationships or on the equations. The simultaneous solution of multiple independent equations involves well-know techniques used in statistical, engineering, physics and mathematical fields. It has not been previously applied to the field of document layout. Also, these equations can be solved by general principles of linear programming, non-linear programming, fuzzy logic or other techniques.

In a preferred embodiment of the present invention, the number of variables exactly matches the number of independent linear equations. In this embodiment, there is only one solution for the designer. That is, the system is able to automatically layout the document for each output device with not only the content objects specified by the designer, but also the design intent of the designer for that document.

Also, in this preferred embodiment, or in another preferred embodiment, the system is able to adjust for situations where there are too many variables compared to the number of independent equations. In one preferred embodiment, the system includes an interactive component. The system can provide feedback in the forms of queries to the designer to allow the designer to select a preferred solution for this particular set of content, relationships, design intent and/or output device. In another preferred embodiment, the system is also able to analyze previous solutions to the particular problem to select a preferred solution or range of solutions automatically.

The system may also include a heuristic approach to “remember” previous solutions and present them as preferred solutions. In any event, the interactive embodiment of the present invention allows a designer to examine multiple solutions, if there is more than one possible solution based on the relationships, and choose the desired solution.

In the preferred embodiment, the system also provides a set of rules or relationships, or allows the designer to select a set of rules or relationships for adjusting the layout to a range of possible of solutions. For example, relationships can be set so that there are no overlapping graphics, images retain their initial aspect ratio, graphics are placed near the text that references them, etc. The system of the preferred embodiment will ensure that these relationships are maintained regardless of the output device.

Another situation that arises is where there may be too few variables compared to the number of independent equations to be solved. The preferred embodiment of the present invention then solves some or all of the relationships “approximately”, that is, by providing a solution that is close within a defined measurement. This can be done by a “least squares” method or other statistical methods.

Another approach to this situation can also be done, in a preferred embodiment, by solving some smaller number of the relationships exactly. The smaller number of relationships to be solved exactly can be done by selecting a maximum number of relationships to be solved or by ranking the relationships in priority.

Yet another approach would be a mix of the two approaches discussed above. This approach may be desired where the approximate solution of all of the equations (relationships) is deemed too far off to be effective. Then the approximate solutions for a reduced number of equations can be selected.

The relationships as discussed above can be collected and reused. This reuse can either be with the existing set of contact objects used on a different output display device, or with a new content set used on the same of different output display device. In a preferred embodiment, the designer is able to preview a layout simulated for an arbitrarily defined output device or for no output device at all. In the preferred embodiment, the process is independent of a particular set of content objects or output display device. Thus, a designer can edit the layout in any view mode. This essentially allows the design intent to be edited without resorting to a specific instance of the publication. Conversely, the process also allows a designer to define special relationships that apply the publication to a specific media device.

In a preferred embodiment, the system provides a layout engine is able to use placeholders that stand in for the actual content objects. The placeholders would have some or all of the properties of the actual content objects. The designer can then switch between a placeholder view and one or more content views.

The overall approach of defining the variable properties of the content objects (including the overall document) and the output devices in terms of independent equations to be solved simultaneously is unique in that it does not require the structural relationships (geometrical placement) between the content objects to be enforced on the designer. Instead the logical or non-structural relationship (such as stylistic formatting, logical references, etc., viewing ability of the output media) between the content objects and the output media is adjusted as necessary so the design intent of the original document is maintained.

Candidate Relationships This preferred embodiment of the present invention also enables the system and processes to analyze publications, both existing and works in progress. This analysis can then generate a set of “candidate” relationships regarding that publication. For example, the system can determine such candidate relationships as the background color, font stylization, placement of images relative to text, etc. These candidate relationships can be presented as feedback or as an analysis tool for the designer to determine if they are design intent or artifacts of the presentation.

The ability to analyze publications, to propose candidate relationships, to accept or reject the candidates and to store those relationships enables a designer to maintain a distinct design concept across multiple publications and/or to multiple output devices. The designer is also able to maintain a unique look-and-feel design, brand identities, and other features without a deliberate and burdensome manual analysis.

The preferred embodiment also allows the analysis of multiple publications to extract common aspects of design intent. This is analysis is more comprehensive than doing so manually and can be used by less sophisticated designers to improve their designs, and to allow existing designs to be mimicked.

Also, the preferred embodiment could also use these candidate relationships to analyze publications and brand identities to identify and emphasize their differences.

In the preferred embodiment, a sequence of candidate relationships can be extracted from an existing publication in real time. The system can then extract a more fundamental set of design relationships from the sequence of extracted candidate relationships that represent a “good design” from that designer's viewpoint.

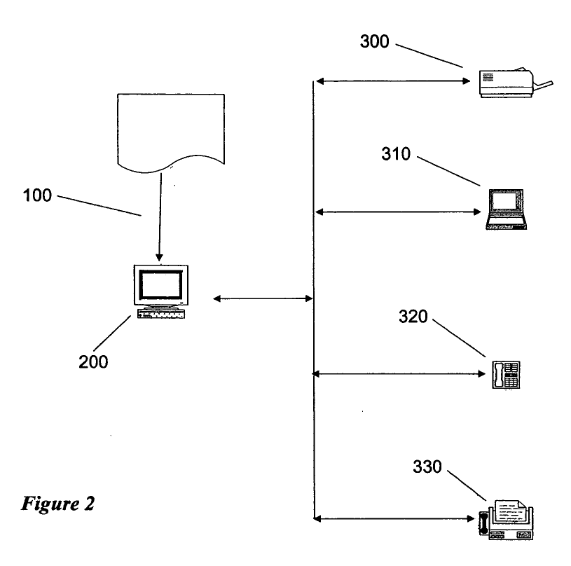

Implementation An implementation of a preferred embodiment is disclosed in FIG. 2. The components of this preferred embodiment include a designer interface 100 connect to the dynamic layout engine 200 residing on either a stand alone computer system or via network to a server. Different output media devices, such as printer 300, computer monitor 310, cell telephone 320, personal digital assistant 330 and other specified or non-specified devices are connected to the dynamic layout engine 200.

In use, the designer arranges the content objects in accordance with the design intent of the designer. The designer can then view the publication either independently from a specified output media device or with respect to a specified media device. The dynamic layout engine 200 then collects the properties of the content objects, the relationships between the content objects and specified output media devices.

The variable values of the properties are then translated into equations. These equations are then solved simultaneously to specify the values of the variables that then determines the final layout of the publication.

If the number of content object relationships and output media relationships are too few to completely specify the variable values, then the dynamic layout engine interacts with the designer to specify additional relationships, such as the fixing the aspect ratio of images, non-overlapping of images, etc., to create a desired solution.

If the number of content object relationships and output media relationships are too many to completely specify the variable values, then the dynamic layout engine will “approximate” solutions for the variable values within defined limits, solve a limited number of the relationships in accordance with a priority order, or a mixture of the two.

In another preferred embodiment, the system is able to dynamically change the layout depending on the output media display devices that the document is to be published. In this preferred embodiment, the designer selects the end users that are to receive the published document. The system recognizes the preferred output media devices that those end users utilize. The system then obtains the properties of those output media devices and creates the specific layout for the document that is to be sent to each of the specified output media devices. The designer may or may not even be aware of the individual layouts for each of the specified media devices. For example, the designer may create a particular document using their design intent and content objects. The designer then selects that the document be broadcast to a number of end users. The system recognizes that one end user prefers to receive publications via print on a particular print device, a second end user prefers to receive publications via HTML email, a third user prefers to receive publications via a WWW web page, a fourth user prefers to receive publications via a handheld wireless appliance, and so forth. The system collects the properties for each of these devices, associates relationships between the content objects, and the devices and creates equations based on these relationships and variable properties. The designer may be queried, if necessary, where input is necessary. Otherwise, the system creates a layout for each device and publishes the desired document with the design intent substantially intact for each of the end users.

In some instances, the system may query the end user for their preference of output media device, if that preference is not known. Also, the output media devices itself may be queried directly by the system for their properties.

Another preferred embodiment provides unique features of “layering” and/or “overlapping” of content objects. This allows new content to be overlaid onto existing content. The overlap is supported while the engineering optimizations are maintained for non-overlapping single layer applications. This allows graphic designers a more intuitive approach while allowing the freedom of “placing the content anywhere”. The non-structural approach of the present invention enables this type of freedom of design intent.

These and other features of the inventions are set forth in the claims. It is to be expressly understood that the exemplary embodiments are intended for descriptive purposes only and are not meant to limit the scope of the claims.

1. A computer implemented method of arranging a plurality of content objects within a publication layout for publishing on one or more of a plurality of output media devices, said method comprising:
defining a set of properties associated with each of said content objects;
defining a set of properties associated with each of said output media devices;
collecting said properties for each of said content objects;
collecting said properties for at least one of said output media devices;
identifying said properties of said content objects and said output media devices that have fixed values;
identifying said properties of said content objects and said output media devices that have variable values;
defining a set of relationships between said properties of said content objects, said relationships relating selected ones of said properties of each of said content objects with selected ones of said properties of other of said content objects;
defining properties of said relationships between said properties of said content objects;
defining a set of relationships between said properties of said content objects and said properties of said output media devices;
translating said relationships into a series of mathematical equations, wherein said variable properties of said content objects and said output media devices become the variables of said mathematical equations;
solving said equations simultaneously for values for said variable properties; and
providing said solved values of said variable properties to create a layout for said publication.

2. A method as recited in claim 1 wherein the number of said relationships between the variable properties is insufficient to completely specify all of said variable properties, wherein the set of said relationships is supplemented by a set of auxiliary relationships chosen to obtain an aesthetically pleasing appearance for the final layout.

3. A method as recited in claim 1 wherein one or more of said variable properties of the content objects or of the said output media are constrained to lie within a range of values, said method applying said additional constraints as additional relationships to be maintained and solving for the resulting values.

4. A method as recited in claim 4 wherein one or more of said variable properties of the content objects or the said output media have a preferred value, said method utilizing the maintenance of the value close in some metric to the preferred value as a auxiliary relationship.

5. A method as recited in claim 1 wherein the number of said relationships between the variable properties is too great to uniquely specify a unique solution of all said variable properties wherein said method further comprises:
approximately solving said equations specifying said relationships while minimizing some metric, such as the sum of the squares of the error in the solution.

6. A method as recited in claim 1 wherein the number of said relationships between said variable properties is too great to uniquely specify a unique solution of all said variable properties wherein said method further comprises:
approximately solving said equations specifying said relationships while minimizing some metric.

7. A method as recited in claim 1 wherein said method includes:
solving said equations by maximizing the number of said relationships solved exactly.

8. A method as recited in claim 1 wherein said method comprises:
successfully fulfilling the maximum number of constraints based on an ordering of said relationships, said ordering being chosen to obtain an aesthetically pleasing appearance for the final layout.

9. A method as recited in claim 1 wherein the layout engine reaches a solution by maximizing the number of said relationships solved exactly.

10. A method as recited in claim 1 wherein said method includes:
identifying those relationships that are not satisfied exactly for the purpose of communicating this information to a designer.

11. A method as recited in claim 1 wherein said method includes:
inferring some of said relationships between said content objects” physical positions from the placement of said content objects within a design.

12. The method of claim 11 wherein said relationships may be viewed through a designers” interface and verified or disposed of as desired.

13. A method as recited in claim 1 wherein the content objects are classified into one or more groups, each group having one or more content elements, said groups having a particular priority ordering chosen for the particular publication.

14. A method as recited in claim 13 wherein the number of said relationships between said variable properties is too great to specify a unique solution of all of said variable properties where in said method includes:
eliminating certain ones of said content objects and said relationship until either an exact solution exists.

15. A computer implemented method of arranging a plurality of content objects within a publication layout for publishing on one or more of a plurality of output media devices, said method comprising:
defining a set of properties associated with each of said content objects;
defining a set of properties associated with each of said output media devices;
collecting said properties for each of said content objects;
collecting said properties for at least one of said output media devices;
identifying said properties of said content objects and said output media devices that have fixed values;
identifying said properties of said content objects and said output media devices that have variable values;
defining a set of relationships between said properties of said content objects, said relationships relating selected ones of said properties of each of said content objects with selected ones of said properties of other of said content objects;
defining properties of said relationships between said properties of said content objects;
defining a set of relationships between said properties of said content objects and said properties of said output media devices;
translating said relationships into a measure of the preferred aesthetics, said measure being represented as a mathematical function wherein said variable properties of said content objects and said output media devices become the variables of said mathematical function;
solving for the values of said variables by minimizing or maximizing the value of said function; and
providing said solved values of said variable properties to create a layout for said publication.

16. A method as recited in claim 15 wherein said method includes:
inferring some of said relationships between said content objects” physical positions from the placement of said content objects within a design.

17. The method of claim 16 wherein said relationships may be viewed through a designers” interface and verified or disposed of as desired.
